(19) United States
(12) Patent Application Publication
(10) Pub. No.: US 2025/0293384 A1
(43) Pub. Date: Sep. 18, 2025

(54) CELL INTEGRATED VENT GAS DIVERTER WITH PARTICLE TRAP

(71) Applicant: GM Global Technology Operations LLC, Detroit, MI (US)

(72) Inventors: SeungHwan Keum, Northville, MI (US); Ronald O. Grover, JR., Northville, MI (US); Derek Frei Lahr, Ann Arbor, MI (US); Xiaoling Chen, Sterling Heights, MI (US)

(21) Appl. No.: 18/603,566

(22) Filed: Mar. 13, 2024

(51) Int. Cl. H01M 50/367; H01M 10/04; H01M 50/107; H01M 50/167; H01M 50/169; H01M 50/249; H01M 50/342

(52) U.S. Cl. CPC H01M 50/367; H01M 10/0431; H01M 50/107; H01M 50/167; H01M 50/169; H01M 50/249; H01M 50/3425; H01M 2220/20

(57) ABSTRACT

A vehicle battery cell venting system includes a battery pack providing electrical power for propulsion of a vehicle. A battery cell includes a battery can enclosing components including an electrolyte. A battery end cap captures an electrolyte portion. A mandrel has a longitudinal bore, the mandrel extending through the electrolyte and disposed on a battery can center axis. An electrolyte generated gas may pass through the longitudinal bore. A shaft is slidably disposed within the longitudinal bore, with a shaft proximal fixed to a vent cap portion of the battery end cap. A circular scoring created in the battery end cap releasably fixes the vent cap portion to the battery end cap and is frangible allowing the vent cap portion to separate from the battery end cap and for the vent cap portion together with the shaft to displace when a battery cell overpressure condition is created.

### INTRODUCTION

The present disclosure relates to electric vehicle batteries and battery venting.

For vehicle batteries, when a battery undergoes thermal propagation, hot gas and particles (ejecta) are vented out. To aid in battery thermal management, vent caps may be used to allow and direct gas and particle ejection into battery vent passages. Vent passage diverters in battery vent passages have been developed to help direct the hot gas and the ejecta, however, vent passage diverters may interfere with operation of the vent caps.

Thus, while current systems and methods to divert battery gas discharge achieve their intended purpose, there is a need for a new and improved system and method to vent gas and ejecta from a battery cell of a vehicle battery pack.

### SUMMARY

According to several aspects, a vehicle battery cell venting system comprises a vehicle having a battery pack providing electrical power for propulsion and operation of systems of the vehicle. A battery cell of the battery pack includes an outer battery can enclosing components of the battery cell including an electrolyte disposed within the battery can. A battery end cap captures a portion of the electrolyte. A mandrel having a tubular-shape has a longitudinal bore extending through the mandrel, the mandrel extending through the electrolyte and disposed on a longitudinal center axis of the battery can. The mandrel permits a gas generated by the electrolyte to pass through the longitudinal bore. A shaft is slidably disposed within the longitudinal bore of the mandrel, a proximal of the shaft being fixed to a vent cap portion of the battery end cap. A circular scoring created in the battery end cap releasably fixes the vent cap portion to the battery end cap. The circular scoring is frangible allowing the vent cap portion to separate from the battery end cap and for the vent cap portion together with the shaft to displace when an overpressure condition is created in the battery cell.

In another aspect of the present disclosure, the longitudinal bore includes a first bore having a first bore diameter A opening into a second bore having a second bore diameter B, with the first bore diameter A being less than the second bore diameter B.

In another aspect of the present disclosure, the shaft includes a main shaft portion having a first shaft diameter C; and the first shaft diameter C is smaller than the first bore diameter A providing for a sliding fit of the main shaft portion within the first bore diameter A.

In another aspect of the present disclosure, the shaft includes a stop block having a block diameter D greater than the first bore diameter A of the longitudinal bore, with the stop block slidably disposed within the second bore.

In another aspect of the present disclosure, the second bore ends at a shoulder; and the stop block slidably fits within the second bore diameter B of the second bore with the stop block contacting the shoulder to end sliding travel of the shaft in a shaft sliding direction.

In another aspect of the present disclosure, a particle trap positioned on the vent cap portion provides a surface viscosity or treatment defining a generally circular-shaped end wall raised above a surface of the vent cap portion to collect and trap particles in an ejecta occurring during battery cell venting. The particle trap defines one of a magnetic material to magnetically attract and hold the particles of ejecta, or a chemical or viscous material to capture the particles coming in direct contact with the particle trap.

In another aspect of the present disclosure, a wedge-shaped member is created on the shaft; and a tapering outer surface of the wedge-shaped member contacts a concomitant-shaped inner tapering surface created in the mandrel to stop travel of the shaft.

In another aspect of the present disclosure, multiple wedge-shaped members extend inwardly from a mandrel inner wall individually including a taper face having a continuous downward diameter reducing shape. The shaft has an upward directed taper body that passes through the wedge-shaped members when a pressure difference from the overpressure condition occurs to stop travel of the shaft against one of the wedge-shaped members.

In another aspect of the present disclosure, the vent cap portion includes multiple concentric brushes or porous materials fixed to an upper surface of the vent cap portion. Gaps or pores are designed to receive and capture at least one particle entrained in an ejecta occurring during battery cell venting.

In another aspect of the present disclosure, the vent cap portion is thinner at a vent cap center than at a vent cap perimeter, rendering the vent cap center easier to bend upon contact by a gas discharged from the battery cell, with the vent cap center forming a curved bowl-shape during bending to improve collection of ejecta particles emitted from the battery cell. A surface treatment is provided to the vent cap portion to attract the ejecta particles, with the surface treatment defining at least one of a brush material and a porous material functioning to attract and trap the ejecta particles, the brush material and the porous material defining a high temperature resistant polymer.

According to several aspects, a method for forming a vehicle battery cell venting system comprises: rolling a positive electrode and a negative electrode at a separator to create a winding; inserting a hollow mandrel through a longitudinal center axis of the winding; joining a bottom insulator at a first end of the winding proximate the negative electrode; coupling a top insulator at a second end of the winding opposite to the negative electrode and proximate to the positive electrode; slidably disposing the bottom insulator with the winding into a can; mounting a cell top assembly defining a header over a positive terminal of the positive electrode and onto the top insulator; slidably inserting a shaft into a longitudinal bore of a mandrel centrally positioned in the can with a portion of the shaft extending beyond a bottom end of the mandrel; end-welding the shaft to a surface of a vent cap portion of a battery end cap; and pushing the battery end cap having the shaft welded to the vent cap portion onto a first end of the can and fixing the battery end cap at a perimeter of the first end of the can.

In another aspect of the present disclosure, the method further includes adding an electrolyte to the header of the cell top assembly and crimping the cell top assembly containing the electrolyte at a second end of the can.

In another aspect of the present disclosure, the method further includes: extending a support ring of the battery end cap circumferentially outward of the vent cap portion to create a supporting surface to receive a portion of the electrolyte; and encapsulating the portion of the electrolyte using a raised shoulder surrounding the support ring when the battery end cap is fixed to the can.

In another aspect of the present disclosure, the method further includes extending a positive terminal outward of the positive electrode and extending a negative terminal outward of the negative electrode.

In another aspect of the present disclosure, the method further includes: creating a first bore diameter A in the longitudinal bore opening into a second bore having a second bore diameter B, wherein the first bore diameter A is less than the second bore diameter B; ending the second bore at a shoulder; providing the shaft with a main shaft portion having a first shaft diameter C and a stop block having a stop block diameter D; forming a first shaft diameter C smaller than the first bore diameter A of the longitudinal bore to provide for a sliding fit of the main shaft portion within the first bore diameter A; and positioning a stop block on the shaft having a stop block diameter D larger than the first bore diameter A such that the stop block slidably fits within the second bore diameter B of the longitudinal bore, with the stop block contacting the shoulder to end sliding travel of the shaft.

In another aspect of the present disclosure, the method further includes: circumferentially welding the bottom insulator to the first end of the winding; welding the bottom insulator to the can after disposing the bottom insulator with the winding into the can; and welding the cell top assembly to the positive terminal of the positive electrode.

In another aspect of the present disclosure, the method further includes creating a circular scoring in the battery end cap, the circular scoring being frangible allowing the vent cap portion to separate from the battery end cap and for the vent cap portion together with the shaft to displace when an overpressure condition is created in the battery cell.

According to several aspects, a method for venting a vehicle battery cell comprises: inserting a hollow mandrel through a longitudinal center axis of a winding; installing the winding into a can; slidably inserting a shaft into a longitudinal bore of a mandrel centrally positioned in the can with a portion of the shaft extending beyond a bottom end of the mandrel; creating a circular frangible scoring in a battery end cap to differentiate a vent cap portion of the battery end cap; end-welding the portion of the shaft extending beyond the bottom end of the mandrel to a surface of the vent cap portion of the battery end cap; creating a battery cell by fixing the battery end cap onto one end of the can and introducing an electrolyte into the can; and rupturing the circular frangible scoring separating the vent cap portion from the battery end cap when an overpressure condition is created in the battery cell to allow the vent cap portion together with the shaft to displace away from the can to vent gas from the battery cell.

In another aspect of the present disclosure, the method further includes: joining a bottom insulator at a first end of the winding proximate a negative electrode; and coupling a top insulator at a second end of the winding opposite to the negative electrode and proximate to a positive electrode.

In another aspect of the present disclosure, the method further includes: mounting a cell top assembly defining a header over a positive terminal of the positive electrode and onto the top insulator; and pushing the battery end cap having the shaft welded thereto onto a first end of the can and fixing the battery end cap at a perimeter of the first end of the can.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a front left perspective view of a vehicle having a vehicle battery cell venting system according to an exemplary aspect;

FIG. 2 is a partial cross-sectional elevational view of a battery cell of the battery cell venting system of FIG. 1;

FIG. 3 is a diagrammatic presentation of steps to manufacture the vehicle battery cell venting system of FIG. 1;

FIG. 4 is a top perspective view of a vent cap portion of a battery end cap of the present disclosure in an initially assembled state having a circular scoring joining the vent cap portion to a body of the battery end cap;

FIG. 5 is a top perspective view of the battery end cap of FIG. 4 following rupture of the circular scoring and displacement of the vent cap portion;

FIG. 6 is a cross sectional elevational view of a modified battery cell of the present disclosure having a particle trap;

FIG. 7 is a cross sectional elevational view of a modified battery cell of the present disclosure having a tapered vent cap stop member;

FIG. 8 is a cross sectional elevational view of a modified battery cell of the present disclosure having a raised edge vent cap portion with a particle trap;

FIG. 9 is a cross sectional elevational view of a modified battery cell of the present disclosure having multiple tapered vent cap stop members;

FIG. 10 is a cross sectional elevational view of a modified battery cell of the present disclosure having a melting phase change material vent cap stop system;

FIG. 11 is a cross sectional elevational view of a modified battery cell of the present disclosure having a vent cap portion with multiple upwardly directed concentric rings to trap particles; and

FIG. 12 is a cross sectional elevational view of a modified battery cell of the present disclosure having a deformable vent cap portion.

### DETAILED DESCRIPTION

The following description is merely exemplary in nature and is not intended to limit the present disclosure, application, or uses.

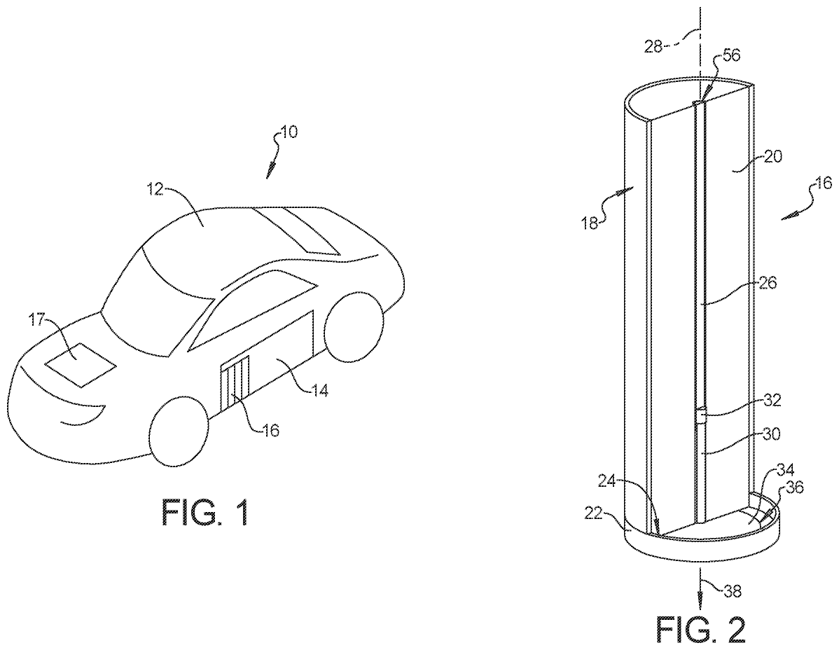

Referring to FIG. 1, a vehicle battery cell venting system 10 is provided for a vehicle 12 having a battery pack 14 providing electrical power for propulsion and operation of multiple systems of the vehicle 12. The vehicle 12 may include a sedan, a sport utility vehicle, a van, a truck or an autonomous vehicle collectively defining a battery electric vehicle having multiple battery cells 16 of the battery pack 14. The vehicle 12 may also include an additional power source 17 including a gasoline engine or a hydrogen fuel cell to provide a portion of a battery charging current or a portion of a propulsion force to aid the battery pack 14 in powering the vehicle 12. According to several aspects the battery cells 16 may include any configuration of battery cell geometry, including cylindrical cells and/or rectangular cells, with a cylindrical cell geometry shown only for illustration.

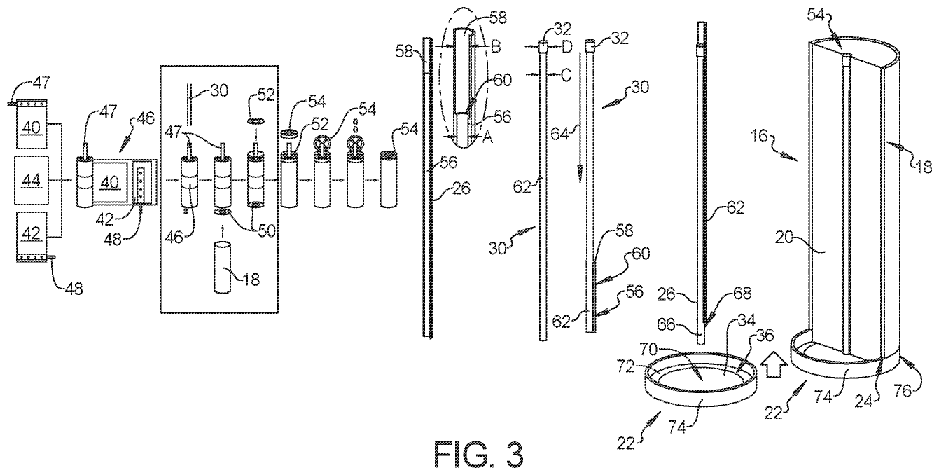

Referring to FIG. 2 and again to FIG. 1, an individual battery cell 16 defining a cylindrical-shaped battery cell includes an outer battery can 18 enclosing components of the battery cell 16. An electrolyte 20 is disposed within battery can 18 with a portion of the electrolyte 20 being captured using a battery end cap 22. The battery end cap 22 may be coupled to the battery can 18 using a weld joint 24 to seal the battery cell 16 from atmosphere. A mandrel 26 has a longitudinal bore 56 described in greater detail in reference to FIG. 3 extending a total length of the mandrel 26. The mandrel 26 extends through the electrolyte 20 and is disposed on a longitudinal center axis 28 of the battery can 18. The mandrel 26 permits gas causing an overpressure condition in the battery cell 16 generated by the electrolyte 20 during a thermal propagation event of the battery cell 16 to pass through the longitudinal bore 27.

A shaft 30 is slidably disposed within the longitudinal bore 27 of the mandrel 26. The shaft 30 includes a stop block 32 having a block diameter greater than a shaft diameter of the shaft 30. The block diameter of the stop block 32 and the shaft diameter of the shaft 30 are smaller than a longitudinal bore diameter of the mandrel 26 to permit a sliding motion of the shaft 30 within the longitudinal bore 27 of the mandrel 26 as described in greater detail in reference to FIG. 3. A proximal of the shaft 30 is fixed to a vent cap portion 34 of the battery end cap 22 as described in greater detail in reference to FIG. 3. The vent cap portion 34 of the battery end cap 22 is releasably fixed to the battery end cap 22 via a circular scoring 36 created in the battery end cap 22. The circular scoring 36 is frangible allowing the vent cap portion 34 to separate from the battery end cap 22, and for the vent cap portion 34 together with the shaft 30 to displace in an exemplary downward direction 38 when an overpressure condition is created in the battery cell 16.

Referring to FIG. 3 and again to FIGS. 1 and 2, a sequence of exemplary manufacturing steps are presented for formation of the battery cell 16. Initially, a positive electrode 40 is positioned proximate to a negative electrode 42. A separator 44 is provided and the positive electrode 40 and the negative electrode 42 are rolled or folded and thereby wound with the separator 44 to create a winding 46. The winding 46 may include a positive terminal 47 extending outward of the positive electrode 40 and a negative terminal 48 extending outward of the negative electrode 42. The hollow mandrel 26 is then inserted through the longitudinal center axis 28 of the winding 46 as described in reference to FIG. 2. A bottom insulator 50 is then joined at a first end of the winding 46 proximate the negative electrode 42. Similarly, a top insulator 52 is then joined at a second end of the winding 46 opposite to the negative electrode 42 and proximate to the positive electrode 40.

The bottom insulator 50 is then circumferentially welded to the first end of the winding 46, and the bottom insulator 50 with the winding 46 are slidably disposed into the can 18. The bottom insulator 50 is also further welded to the can 18. A cell top assembly 54 defining a header is mounted over the positive terminal 47 of the positive electrode 40 and onto the top insulator 52. The cell top assembly 54 is then welded to the positive terminal 47 of the positive electrode 40 extending outward of the second end of the can 18. The electrolyte 20 described in reference to FIG. 2 is added to the header of the cell top assembly 54 and the cell top assembly 54 containing the electrolyte 20 is circumferentially crimped at the second end of the can 18.

The shaft 30 is slidably inserted into the longitudinal bore 56 of the mandrel 26 centrally positioned in the can 18. The longitudinal bore 56 has a first bore diameter A and opens into a second bore 58 having a second bore diameter B. According to several aspects the first bore diameter A is less than the second bore diameter B. The second bore 58 ends at a shoulder 60. The shaft 30 includes a main shaft portion 62 having a first shaft diameter C and the stop block 32 has a stop block diameter D. According to several aspects, the first shaft diameter C is smaller than the first bore diameter A of the longitudinal bore 56 providing for a sliding fit of the main shaft portion 62 within the first bore diameter A. According to several aspects, the stop block diameter D is larger than the first bore diameter A and therefore the stop block 32 only slidably fits within the second bore diameter B of the longitudinal bore 56. The stop block 32 contacts the shoulder 60 to end sliding travel of the shaft 30 in a shaft sliding direction 64.

A portion 66 of the shaft 30 extending beyond a bottom end 68 of the mandrel 26 is end-welded to a surface 70 of the vent cap portion 34 of the battery end cap 22. A support ring 72 of the battery end cap 22 extends circumferentially outward of the vent cap portion 34 and creates a supporting surface to receive a portion of the electrolyte 20. A raised shoulder 74 surrounding the support ring 72 encapsulates a portion of the electrolyte 20 when the battery end cap 22 is fixed to the can 18. The battery end cap 22 having the shaft 30 welded thereto is then pushed onto a bottom or a first end 76 of the can 18 and is circumferentially welded using the weld joint 24 shown in reference to FIG. 2 at a perimeter of the first end 76 of the can 18 to complete manufacture of the battery cell 16.

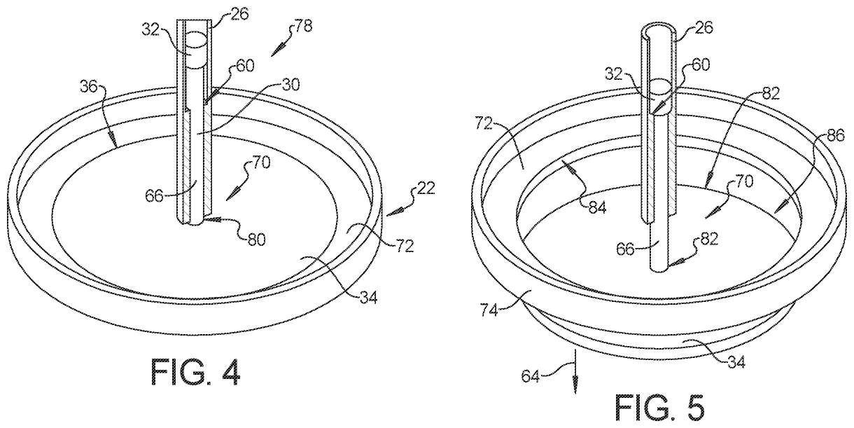

Referring to FIG. 4 and again to FIGS. 1 through 3, an assembly 78 including the battery end cap 22, the mandrel 26 and the shaft 30 has the vent cap portion 34 releasably fixed to the support ring 72 using the scoring 36. The scoring 36 provides a pressure tight 360 degree seal of the vent cap portion 34 to the support ring 72 to seal the electrolyte 20 and the internal features of the battery cell 16 from atmosphere under normal operating conditions of the battery cell 16. A weld joint 80 fixes the shaft 30 to the surface 70 of the vent cap portion 34 as described above in reference to FIG. 3. The stop block 32 is positioned above and not in contact with the shoulder 60 in this initial construction condition of the assembly 78, therefore the vent cap portion 34 may be displaced away from the support ring 72 if a subsequent high pressure condition such as a battery thermal propagation event occurs during subsequent operation of the battery cell 16.

Referring to FIG. 5 and again to FIG. 4, under predetermined operating conditions of the battery cell 16, including during a battery cell internal overpressure condition caused for example by a battery thermal propagation, gas pressure within the battery cell 16 acting in the downward direction 64 causes rupture of a frangible 360-degree seal provided by the intact scoring 36. The vent cap portion 34 is thereby allowed to displace away from the support ring 72 in the downward direction 64 as a convex-shaped circumferential edge 82 of the vent cap portion 34 separates from a concave-shaped circumferential wall 84 of the support ring 72. As the vent cap portion 34 separates from the support ring 72 a vent path 86 is opened to allow battery gases and ejecta to escape from the battery cell 16. The displacement of the vent cap portion 34 in the downward direction 64 is stopped when the stop block 32 directly contacts the shoulder 60, thereby maintaining the vent path 86 open without allowing the vent cap portion 34 to dislodge and contact and possibly damage any portion of the battery pack 14. A length of the portion 66 of the shaft 30 extending beyond the bottom end 68 of the mandrel 26 as shown in reference to FIG. 3 is therefore predetermined to provide for a maximum opening of the vent path 86 while allowing for retention of the vent cap portion 34 by the stop block 32.

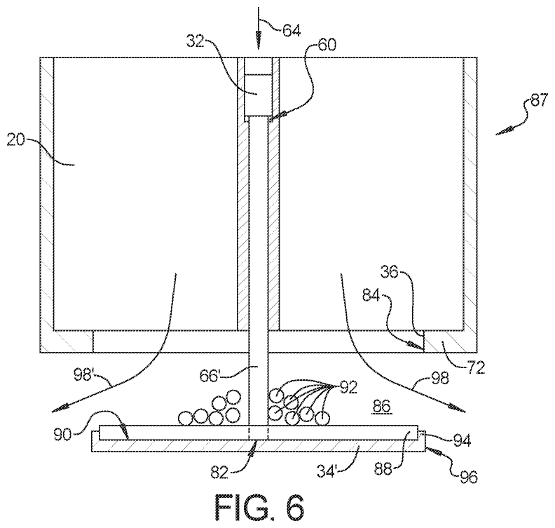

Referring to FIG. 6 and again to FIGS. 3 through 5, according to further aspects, a battery cell 87 is modified from the battery cell 16 to further maximize capture of ejecta escaping from the battery cell 87. A particle trap 88 provides a surface viscosity or treatment defining a generally circular-shaped end wall raised above a surface 90 of a modified vent cap portion 34′ to collect and trap particles 92 in the ejecta occurring during battery cell venting. The particle trap 88 may define a magnetic material to magnetically attract and hold the particles 92 of ejecta, or a chemical or viscous material to capture the particles 92 coming in direct contact with the particle trap 88. The particle trap 88 may be positioned and retained on the surface 90 of the modified vent cap portion 34′ using a raised end wall 94 of the modified vent cap portion 34′. The raised end wall 94 allows for an outer surface 96 of the modified vent cap portion 34′ to be machined or modified to perform the function of the scoring 36 as the modified vent cap portion 34′ separates from the concave-shaped circumferential wall 84 of the support ring 72. Battery cell gases may then be allowed to fully exit from the battery cell 16 via flow paths 98, 98′. Similar to the discussion above with respect to FIG. 5, a length of the portion 66′ of the shaft 30 extending beyond the bottom end 68 of the mandrel 26 as shown in reference to FIG. 3 is predetermined to provide for a maximum opening for the flow paths 98, 98′ while allowing for retention of the modified vent cap portion 34′ by the stop block 32.

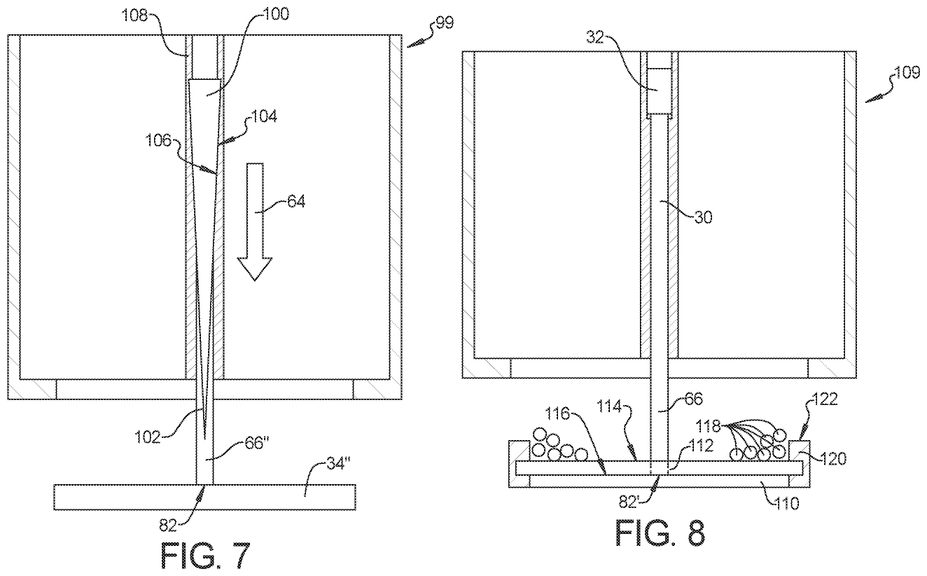

Referring to FIG. 7 and again to FIGS. 3 through 6, a battery cell 99 is modified from the battery cell 16 to improve vent cap positioning during gas escape from the battery cell 99. As an alternative to the use of the stop block 32, a shaft tip shape is designed with a shape that passes through a wedge channel when a pressure difference from the thermal propagation ejection occurs. Allowance for retention of a modified vent cap portion 34″ is provided by a wedge-shaped member 100 created on a modified shaft 102. A tapering outer surface 104 of the wedge-shaped member 100 contacts a concomitant-shaped inner tapering surface 106 of a modified mandrel 108 to stop travel of the modified shaft 102 in the downward direction 64 following rupture of the circular scoring 36. Further attachment and functions of a modified vent cap portion 34″ are similar to the previous vent cap portion 34, 34′ designs discussed above. The tapering geometries of the wedge-shaped member 100 provides an additional advantage over the stop block 32. In the event the battery pack 14 is flipped over and is upside-down, the wedge geometry ensures frictional contact of the wedge-shaped member 100 with the tapering surface 106 to hold the modified vent cap portion 34″ in the open position for gas venting even in the flipped over condition.

Referring to FIG. 8 and again to FIG. 6, according to further aspects, a battery cell 109 is modified from the battery cell 16 to further maximize capture of ejecta escaping from the battery cell 109. To further maximize capture of ejecta escaping from the battery cell 16 from vent gas and ejecta emitted from the battery cell 16 if a thermal propagation of the battery cell 16 occurs, a vent cap portion 110 is modified from the vent cap portions 34, 34′, 34″ and provides a particle trap 112 having a surface viscosity or treatment defining a generally circular-shaped surface 114 raised above a surface 116 of the vent cap portion 110 to collect and trap particles 118 exiting the battery cell 16 in the ejecta during battery cell venting. An additional end wall 120 on an outer perimeter of the vent cap portion 110 and includes a surface 122 raised above the particle trap 112 to further trap the particles 118.

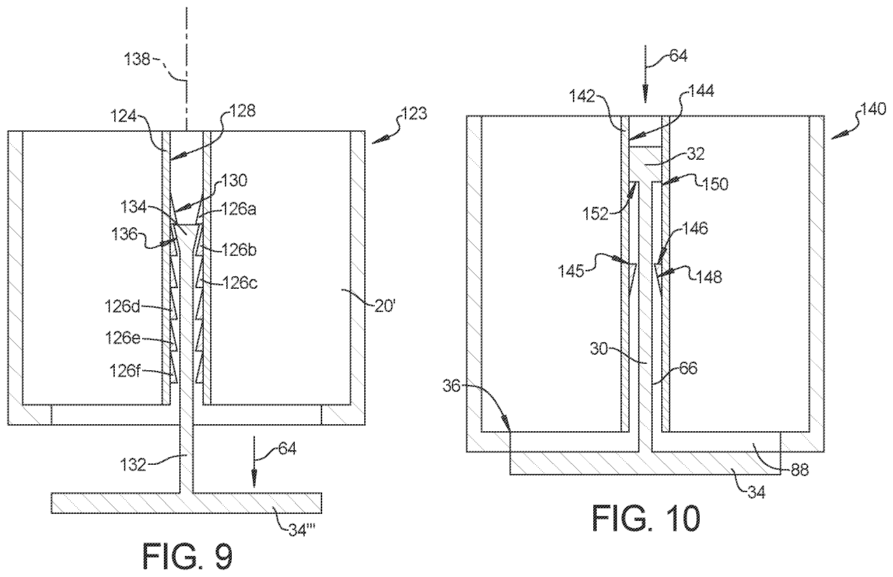

Referring to FIG. 9 and again to FIGS. 6 and 8, according to further aspects, a battery cell 123 is modified from the battery cell 16 to improve vent cap positioning during gas escape from the battery cell 123. As an alternative to the use of stop block 32, a mandrel 124 includes multiple wedge-shaped members 126a, 126b, 126c, 126d, 126e, 126f extending inwardly from a mandrel inner wall 128. Each of the wedge-shaped members 126a, 126b, 126c, 126d, 126e, 126f include a taper face 130 designed with a continuous downward diameter reducing shape. A shaft 132 is modified from the shaft 30 to include an upward directed taper body 134 that passes through the wedge-shaped members 126a, 126b, 126c, 126d, 126e, 126f when a pressure difference from the thermal propagation ejection occurs pushing the shaft 132 in the downward direction 64. Multiple positions of the taper body 134 and thereby the shaft 132 are permitted for different retention positions of a modified vent cap portion 34′″ as a taper face 136 of the taper body 134 contacts successive ones of the wedge-shaped members 126a, 126b, 126c, 126d, 126e, 126f. The mandrel 124 and the shaft 132 are both coaxially aligned on a longitudinal center axis 138 of the battery cell 123.

With continuing reference to FIG. 9, further functions of a modified vent cap portion 34″ are similar to the previous vent cap portions 34, 34′, 34″ designs discussed above. The tapering geometries of the wedge-shaped members 126a, 126b, 126c, 126d, 126e, 126f and the taper body 134 provide an additional advantage over the stop block 32. In the event the battery cell 123 is flipped over and is upside-down, the wedge geometry ensures frictional contact of one of the wedge-shaped members 126a, 126b, 126c, 126d, 126e, 126f with the taper face 136 of the taper body 134 to hold the modified vent cap portion 34′″ in the open position for gas venting even in the flipped over condition.

Referring to FIG. 10, according to further aspects, a battery cell 140 is modified from the battery cell 16 to modify vent cap positioning during gas escape from the battery cell 140. A mandrel 142 is hollow and is centrally positioned within battery cell 140 having an inner wall 144. As an alternative to the use of the shoulder 60, the mandrel 142 includes a single wedge-shaped member 145 extending inwardly from a mandrel inner wall 144 having an upward directed contact face 146. The wedge-shaped member 145 also includes a taper face 148 designed with a continuous upward diameter reducing shape oriented opposite to the geometry of the wedge-shaped members 126a, 126b, 126c, 126d, 126e, 126f described in reference to FIG. 9. A melting phase change material 150 is initially positioned within a bore of the mandrel 142 and beneath a stop face 152 of the stop block 32. A single direction of movement of the shaft 30 in the downward direction 64 is initiated when the melting phase change material 150 is contacted by battery cell gas ejected during a thermal propagation event which melts melting phase change material 150. The shaft 30 and the vent cap portion 34 displace in the downward direction 64 until the stop face 152 of the stop block 32 contacts the contact face 146.

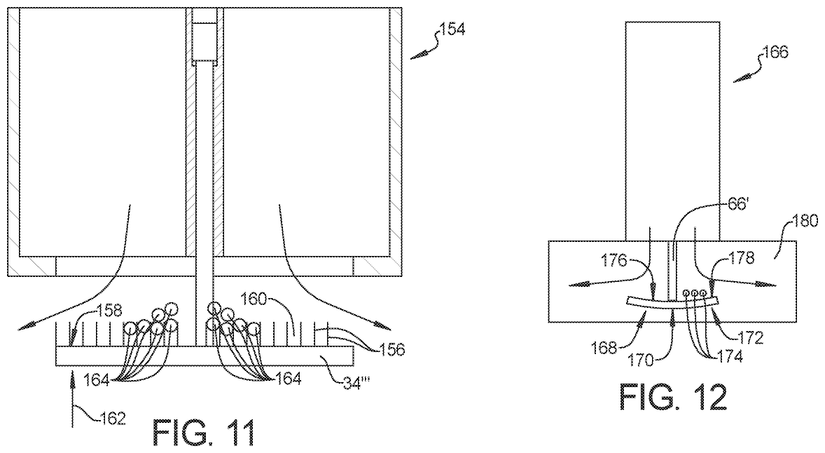

Referring to FIG. 11, according to further aspects, a battery cell 154 is modified from the battery cell 16 to modify vent cap positioning during gas escape from the battery cell 154. The vent cap portion 34″ is modified to include multiple upwardly directed porous materials or wires 156 fixed to an upper surface 158 of the vent cap portion 34″. A gap 160 is provided between successive ones of the concentric wires 156 which opens in an upward direction 162. The gap 160 is sized to receive and capture at least one and according to several aspects multiple particles 164 entrained in the ejecta occurring during battery cell 154 venting. The gap 160 may be less than or equal to approximately 100 μm.

Referring to FIG. 12, according to further aspects, a battery cell 166 is modified from the battery cell 16 to provide a modified vent cap portion 168 such that the vent cap portion 168 is thinner at a vent cap center 170 than at a vent cap perimeter 172, which makes the vent cap center 170 easier to bend upon contact by a gas discharged from the battery cell 166. During bending the vent cap center 170 forms a curved bowl-shape to improve collection of particles 174 ejected. A surface treatment 176 may also be provided to the vent cap portion 168 to attract ejecta particles 174. For example, the surface treatment 176 may define a brush material or a porous material which functions to attract and trap the particles 174. The brush material or the porous material is made of soft but high temperature resistant polymers. A roughness enhancement surface treatment 178 may also be provided to further aid in particle capture. The curved bowl-shape and the surface treatment 176 help retain the particles 174 against discharge of the particles 174 into a header 180 that receives the gas discharged from the battery cell 166.

A vehicle battery cell venting system 10 of the present disclosure offers several advantages. These include integrating a diverter into a battery cell. A vent is connected to a stop block through the mandrel. When the vent opens, the vent cap lifts to a pre-defined height. The vent cap serves as a diverter and a particle trap. The vehicle battery cell venting system 10 thereby prevents thermal and mechanical damage to the battery module and/or to battery pack structure.

What is claimed is:

1. A vehicle battery cell venting system, comprising:
a vehicle having a battery pack providing electrical power for propulsion and operation of systems of the vehicle;
a battery cell of the battery pack including an outer battery can enclosing components of the battery cell including an electrolyte disposed within the battery can;
a battery end cap capturing a portion of the electrolyte;
a mandrel having a longitudinal bore extending through the mandrel, the mandrel extending through the electrolyte and disposed on a longitudinal center axis of the battery can, the mandrel permitting a gas generated by the electrolyte to pass through the longitudinal bore; and
a shaft slidably disposed within the longitudinal bore of the mandrel, a proximal end of the shaft being fixed to a vent cap portion of the battery end cap; and
a circular scoring created in the battery end cap and releasably fixing the vent cap portion to the battery end cap, the circular scoring being frangible allowing the vent cap portion to separate from the battery end cap and for the vent cap portion together with the shaft to displace when an overpressure condition is created in the battery cell.

2. The vehicle battery cell venting system of claim 1, wherein the longitudinal bore includes first bore having a first bore diameter A opening into a second bore having a second bore diameter B, with the first bore diameter A being less than the second bore diameter B.

3. The vehicle battery cell venting system of claim 2, wherein:
the shaft includes a main shaft portion having a first shaft diameter C; and
the first shaft diameter C is smaller than the first bore diameter A providing for a sliding fit of the main shaft portion within the first bore diameter A.

4. The vehicle battery cell venting system of claim 3, wherein the shaft includes a stop block having a block diameter D greater than the first bore diameter A of the longitudinal bore, with the stop block slidably disposed within the second bore.

5. The vehicle battery cell venting system of claim 4, wherein:
the second bore ends at a shoulder; and
the stop block slidably fits within the second bore diameter B of the second bore with the stop block contacting the shoulder to end sliding travel of the shaft in a shaft sliding direction.

6. The vehicle battery cell venting system of claim 1, further including a particle trap positioned on the vent cap portion providing a surface viscosity or treatment defining a generally circular-shaped end wall raised above a surface of the vent cap portion to collect and trap particles of an ejecta occurring during battery cell venting, the particle trap defining one of a magnetic material to magnetically attract and hold the particles of the ejecta, or a chemical or viscous material to capture the particles of the ejecta coming in direct contact with the particle trap.

7. The vehicle battery cell venting system of claim 1, further including:
a wedge-shaped member created on the shaft; and
a tapering outer surface of the wedge-shaped member contacting a concomitant-shaped inner tapering surface created in the mandrel to stop travel of the shaft.

8. The vehicle battery cell venting system of claim 1, further including:
multiple wedge-shaped members extending inwardly from a mandrel inner wall individually including a taper face having a continuous downward diameter reducing shape; and
the shaft having an upward directed taper body that passes through the wedge-shaped members when a pressure difference from the overpressure condition occurs to stop travel of the shaft against one of the wedge-shaped members.

9. The vehicle battery cell venting system of claim 1, wherein:
the vent cap portion includes multiple wires fixed to an upper surface of the vent cap portion; and
a gap being provided between successive ones of the wires opening in an upward direction, the gap receiving and capturing at least one particle entrained in an ejecta occurring during battery cell venting.

10. The vehicle battery cell venting system of claim 1, wherein:
the vent cap portion is thinner at a vent cap center than at a vent cap perimeter, rendering the vent cap center easier to bend upon contact by a gas discharged from the battery cell, with the vent cap center forming a curved bowl-shape during bending to improve collection of ejecta particles emitted from the battery cell; and
a surface treatment provided to the vent cap portion to attract the ejecta particles, with the surface treatment defining at least one of a brush material and a porous material functioning to attract and trap the ejecta particles, the brush material and the porous material defining a high temperature resistant polymer.

11. A method for forming a vehicle battery cell venting system, comprising:
rolling a positive electrode and a negative electrode and a separator to create a winding;
inserting a hollow mandrel through a longitudinal center axis of the winding;
joining a bottom insulator at a first end of the winding proximate the negative electrode;
coupling a top insulator at a second end of the winding opposite to the negative electrode and proximate to the positive electrode;
slidably disposing the bottom insulator with the winding into a can;
mounting a cell top assembly defining a header over a positive terminal of the positive electrode and onto the top insulator;
slidably inserting a shaft into a longitudinal bore of a mandrel centrally positioned in the can with a portion of the shaft extending beyond a bottom end of the mandrel;
end-welding the shaft to a surface of a vent cap portion of a battery end cap; and
pushing the battery end cap having the shaft welded to the vent cap portion onto a first end of the can and fixing the battery end cap at a perimeter of the first end of the can.

12. The method of claim 11, further including adding an electrolyte to the header of the cell top assembly and crimping the cell top assembly containing the electrolyte at a second end of the can.

13. The method of claim 12, further including:
extending support ring of the battery end cap circumferentially outward of the vent cap portion to create a supporting surface to receive a portion of the electrolyte; and
encapsulating the portion of the electrolyte using a raised shoulder surrounding the support ring when the battery end cap is fixed to the can.

14. The method of claim 11, further including extending a positive terminal outward of the positive electrode and extending a negative terminal outward of the negative electrode.

15. The method of claim 11, further including:
creating a first bore diameter A in the longitudinal bore opening into a second bore having a second bore diameter B, wherein the first bore diameter A is less than the second bore diameter B;
ending the second bore at a shoulder;
providing the shaft with a main shaft portion having a first shaft diameter C and a stop block having a stop block diameter D;
forming a first shaft diameter C smaller than the first bore diameter A of the longitudinal bore to provide for a sliding fit of the main shaft portion within the first bore diameter A; and
positioning a stop block on the shaft having a stop block diameter D larger than the first bore diameter A such that the stop block slidably fits within the second bore diameter B of the longitudinal bore, with the stop block contacting the shoulder to end sliding travel of the shaft.

16. The method of claim 11, further including:
circumferentially welding the bottom insulator to the first end of the winding;
welding the bottom insulator to the can after disposing the bottom insulator with the winding into the can; and
welding the cell top assembly to the positive terminal of the positive electrode.

17. The method of claim 11, further including creating a circular scoring in the battery end cap, the circular scoring being frangible allowing the vent cap portion to separate from the battery end cap and for the vent cap portion together with the shaft to displace when an overpressure condition is created in the battery cell.

18. A method for venting a vehicle battery cell, comprising:
inserting a hollow mandrel through a longitudinal center axis of a winding;
installing the winding into a can;
slidably inserting a shaft into a longitudinal bore of a mandrel centrally positioned in the can with a portion of the shaft extending beyond a bottom end of the mandrel;
creating a circular frangible scoring in a battery end cap to differentiate a vent cap portion of the battery end cap;
end-welding the portion of the shaft extending beyond the bottom end of the mandrel to a surface of the vent cap portion of the battery end cap;
creating a battery cell by fixing the battery end cap onto one end of the can and introducing an electrolyte into the can; and
rupturing the circular frangible scoring separating the vent cap portion from the battery end cap when an overpressure condition is created in the battery cell to allow the vent cap portion together with the shaft to displace away from the can to vent gas from the battery cell.

19. The method of claim 18, further including:
joining a bottom insulator at a first end of the winding proximate a negative electrode; and
coupling a top insulator at a second end of the winding opposite to the negative electrode and proximate to a positive electrode.

20. The method of claim 19, further including:
mounting a cell top assembly defining a header over a positive terminal of the positive electrode and onto the top insulator; and
pushing the battery end cap having the shaft welded thereto onto a first end of the can and fixing the battery end cap at a perimeter of the first end of the can.
